(19) United States
(12) Patent Application Publication
(10) Pub. No.: US 2020/0197945 A1
(43) Pub. Date: Jun. 25, 2020

(54) DEVICE FOR GRINDING FOOD GRAINS AND MILL COMPRISING SUCH A GRINDING DEVICE

(71) Applicant: PSP, Quingey (FR)

(72) Inventors: Thierry GOURAND, Bans (FR); Thibaud PERREY, Franois (FR)

(21) Appl. No.: 16/634,850

(22) PCT Filed: Jul. 20, 2018
(86) PCT No.: PCT/FR18/51873

§ 371 Date: Jan. 28, 2020

(30) Foreign Application Priority Data
Jul. 28, 2017 (FR) 1757174

(51) Int. Cl. B02C 2/10; A47J 42/10; A47J 42/38; B02C 18/28

(52) U.S. Cl. CPC B02C 2/10; B02C 18/28; A47J 42/38; A47J 42/10

(57) ABSTRACT

The device for grinding food grains such as flaxseed, includes a bulb rotatably within a bowl. The bulb and the bowl together delimit a functional area, a lower area of which includes a device for moving the grain to a lower area having teeth to grind the grain. There is a device for maintaining, between the bulb and the bowl, at the level of the functional area, a clearance to allow for the grinding of the grains and to avoid all contact between the bulb and the bowl at the level of the space. The space is formed so as to prevent any grains returning from the lower area to the upper area. The invention further concerns a mill equipped with such a device for grinding food grains.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention concerns a device for grinding food grains, such as flaxseed, by means of a mill, the milling device comprising a bulb with a top and a base, an annular bowl having an upper edge and a lower edge, in which the bulb is suited to be rotated when the mill is actuated by means of an axial rod, wherein the bulb and the bowl together delimit a functional area, an upper area of which includes means for moving the grain to a lower area having gearing, consisting of a first set of teeth extending over an outer wall of the bulb, and a second set of teeth extending over an inner wall of the bowl, to grind the grains.

The invention additionally concerns a mill for grinding food grains, such as flaxseed, equipped with such a milling device.

### 2. Description of Related Art Including Information Disclosed Under 37 CFR 1.97 and 37 CFR 1.98.

Because they have numerous nutritional benefits for the body and additionally serve to diversify the flavours and textures on our plates by providing the crunchiness that generally seduces the palate, food grains are increasingly popular with consumers.

However, it is well known that the grains offered on the market, such as flaxseeds, have shells that are too resistant to the human digestive system. In order to allow for complete assimilation of the nutrients contained in the grain and prevent them being simply excreted intact without the body benefiting from all of their nutrients, it is thus indispensable to break their shells finely by grinding them before they are incorporated into a dish.

Currently, for lack of a device specifically intended for this purpose, consumers generally do this by means of a mortar, or a conventional spice mill.

The former solution is tedious, particularly when significant amounts of grain must be ground, and thus is not conducive to their consumption.

Additionally, it has been observed that the grinding mechanism with which dry spice mills are equipped is incompatible with the fatty character of food grains, in particular flaxseed. In fact, it has been found that the grains slide between the unsuitable teeth of the mechanism without being properly ground, and progressively build up there, thus resulting not only in low output—and thus loss of product—but also in accidental clogging of the mills used. Given that the latter often cannot be easily dismantled, this has the disadvantage that residues of partially ground grains inevitably remain therein, even after cleaning, and end up rotting, thus becoming unsuited for consumption.

Additionally, some of the mechanisms used may have the problem of inopportune wear of their gearing due to close contact between the teeth. The consequence of this is that there is a risk of particles of the material of the teeth breaking off during the grinding of the grains and contaminating the grind obtained both in terms of aesthetics and in terms of quality. Moreover, these particles may prove harmful if ingested.

### BRIEF SUMMARY OF THE INVENTION

The objective of this invention is to propose a device specifically designed for grinding food grains, such as flaxseed, by means of a mill, in order both to remedy the tediousness of using a mortar and to avoid all of the disadvantages listed above in relation to the inappropriate use of a conventional dry spice mill.

In other words, the objective of this invention is to propose a device allowing for the grinding of food grains, such as flaxseed, easily, quickly, and effectively, both in quantitative and qualitative terms, with this device also having the advantage that it can be thoroughly cleaned without the need for tools to dismantle its mechanism, so as to reliably provide a grind of impeccable freshness.

To this end, this invention concerns a grinding device as described in the preamble, characterised in that it includes means for maintaining, between the bulb and the bowl, at the level of the functional area, a clearance designed to be suitable both to allow for the grinding of the grains and to avoid all contact between the bulb and the bowl at the level of the space, and that the space is formed so as to prevent any grains returning from the lower area to the upper area.

By means of such a structure, the device according to the invention allows both for perfect grinding of the grains, increased mill output, and prevents particles resulting from untimely erosion of the teeth of the mechanism contaminating the grind.

According to one feature of the device according to the invention, the size of the clearance remains constant over the entire height of the functional area. It is preferably greater than or equal to 0.1 mm and less than or equal to the thickness of the grain to be ground, e.g., greater than or equal to 0.1 mm and less than or equal to 0.4 mm.

According to one preferred embodiment, the outer wall of the bulb and the inner wall of the bowl are frustoconical over the entirety of the functional area, having an identical cone angle between 6 and 10°, e.g. 8°.

Thus, the bulb and the bowl have surfaces that are equidistant at all points, holding the food grain that progressively enters between them and preventing its return when the bulb is rotated within the bowl, unlike what is observed with the use of a conventional dry space grinding mechanism.

The invention further provides that the means for moving the grain to a lower area of the functional area may include, on the one hand, a plurality of helical grooves having a starting end and a terminating end and extending from the top of the bulb around its outer wall over a length, corresponding to one rotation of the bulb, between a quarter turn and a three-quarter turn, wherein the depth of the grooves progressively decreases between their starting end and their terminating end, and, on the other hand, a plurality of splines staggered over the inner wall of the bowl and extending over the inner wall of the bowl and extending from its upper edge towards its lower edge.

Preferably, the length of the grooves corresponds to one half-turn of the bulb.

Additionally, the splines are preferably provided such that their axis forms an angle α of between 85 and 95° with a tangent of the circle defined by an upper or lower edge of the bowl, whilst their depth decreases progressively in the direction of the lower edge of the bowl.

One additional feature of the invention is defined by the fact that the second set of teeth, extending over the inner wall of the bowl, preferably includes a plurality of identical groups, each contained between two consecutive splines and consisting of teeth of differing heights in order of size.

A structure of the functional area having the characteristics described above advantageously allows for an increase in the output of the mill. The helical grooves of the bulb force the food grain, which is held between the walls delimiting the functional area and prevented from returning, down to the small teeth in the lower area of the functional area, where they are ground.

One additional feature of the invention is defined by the fact that the bowl includes a shoulder extending between its lower edge and its inner wall, whilst the bulb includes a plurality of fins extending along a radial axis around its outer wall at the level of its base, with the fins being designed so as to rest on the shoulder and having a length adapted to the depth of the shoulder.

Advantageously, the fins allow both for translationally stopping the bulb within the bowl in order to maintain an optimal functional clearance between the bulb and the bowl and for scraping off the grind so as to progressively and automatically evacuate it from the bowl, to which it inevitably sticks.

According to an additional feature of the invention, this milling device additionally includes means for temporarily joining the bulb with the bowl, allowing them to be dismantled without the need for specific tools and then cleaned.

According to a preferred embodiment, the means for temporary joining are defined by a flange that includes a U-shaped part having two lateral branches and one transverse branch on which the bulb is rotatably mounted, wherein the free ends of the two lateral branches are joined by a ring that extends around the bulb and has a diameter adapted to that of the external face of the bowl, wherein the ring and the bowl include means for holding the flange in place relative to the bowl.

The latter may include at least one pair of legs extending in a diametrically opposite direction towards the inside of the wing at its free edge and at least one pair of diametrically opposite L-shaped grooves on the outer surface of the bowl between its lower edge and a collar bordering its upper edge, with the grooves including a first portion that extends perpendicularly to the edges of the bowl and a second portion that extends parallel to the collar, wherein each of the legs includes a slot suited to cooperate with a lug extending in an appropriate fashion within the second portion of a groove.

The invention further concerns a mill for grinding food grains, such as flaxseed, characterised in that it includes a grinding device with the aforementioned characteristics, integrated with a body containing a housing to store the food grain being ground.

According to a preferred embodiment, the body includes an upper portion in the shape of a funnel, the tubular part of which has a diameter adjusted to that of the inner wall of the bowl, and a lower portion having a diameter adjusted to that of the collar bordering on the upper edge of the bowl and forming, with the upper portion, a shoulder to which the collar may be connected by fastening means.

An additional feature of the mill according to the invention is that the shoulder includes at least one rib formed so as to cooperate with a groove of a corresponding shape included on the upper surface of the collar.

### BRIEF DESCRIPTION OF THE SEVERAL VIEWS OF THE DRAWINGS

The invention, as well as other features and advantages thereof, will be better understood in the light of the following description of an embodiment provided by way of example only and without limitation. The description should be read in conjunction with the drawings appended hereto.

FIG. 1 shows an exploded perspective view of a milling device according to the invention.

FIG. 2 shows a longitudinal cross-sectional view of a mill according to the invention.

FIG. 3 is an exploded longitudinal sectional view of the mill of FIG. 2.

FIG. 4 is a partial cross-sectional view of the bulb and the bowl of the milling device of FIG. 1 in the nested position.

FIG. 5 is an enlarged sectional view of the detail D of FIG. 4.

FIGS. 6 and 7 are perspective views from below and above of the bowl of the milling device of FIG. 1.

FIGS. 8 and 9 are perspective views from below and above of the bulb of the milling device of FIG. 1.

### DETAILED DESCRIPTION OF THE INVENTION

By reference to the drawings, this invention concerns a device 1 for milling food grains, such as flaxseed, to be mounted in a body 11 of a mill 10.

It includes an annular bowl 2, a bulb 3 suited to be rotated within the bowl 2 by means of an axial rod 4 that extends its tip 31, and a flange 5 connecting the bulb 3 and the bowl 2.

It should be noted that, independently of the rod 4, which is provided in metal, the various components of the milling device 1 are preferably made of plastic, such as a plastic of the polyacetal (POM) family, or any other material having equivalent characteristics that is suitable for use in food preparation.

The body 11 of the mill 10 may be made, e.g., of wood, plastic, glass, or any other material selected, in particular, based on the final aesthetic appearance that is desired. As can be seen in the drawings, the body 11 of the mill 10 contains an upper housing 110 in the shape of a funnel, the tubular part of which has a diameter adjusted to that of the inner wall 20 of the bowl 2, and a lower housing 111 that communicates with the tubular part of the upper housing 110, which is suited to contain the assembly consisting of the bulb 2 and the bowl 3. The upper housing 110 is closed by a cap 25 that may be threaded onto the axial rod 4 and affixed to the body 11 of the mill 10 by conventional removable fastening means such as screws. An actuator button 26 on the free end of the axial rod 4 that protrudes from the cap 25 is also provided.

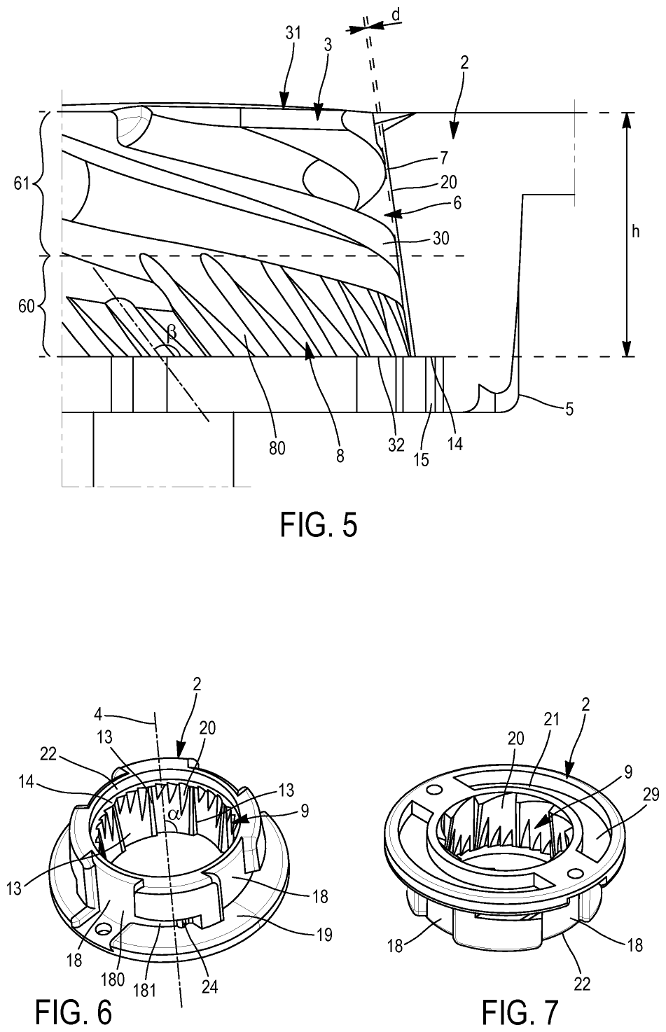

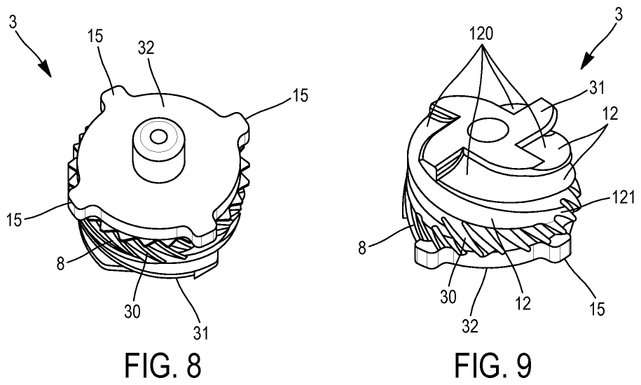

The bulb 3 and the bowl 2 are formed such that, together, they delimit a functional area 6 towards which the food grain contained in the body 11 of the mill 10 is moved by gravity in order to be ground therein. In fact, the functional area 6 corresponds to the volume between the outer wall 30 of the bulb 3 and the inner wall 20 of the bowl 2 and extending between the top 31 and the base 32 of the bulb 3 (cf. FIGS. 4 and 5). It includes an upper area 61 suited to cause the food grain to move towards a lower area 60 having gearing in order to grind it, and which is formed by a first set 8 of teeth extending over the outer wall 30 of the bulb 3 and a second set 9 of teeth extending over the inner wall 20 of the bowl 2.

In the embodiment shown in the drawings, the outer wall 30 of the bulb 3 and the inner wall 20 of the bowl 2 are frustoconical over the entire functional area 6, having an identical cone angle, preferably on the order of 8°. Due to this structure, the size d of the functional clearance 7 between the bulb 3 and the bowl 2 at the level of the functional area 6 remains constant over the entire height h of the latter (cf. FIG. 5). It should be noted that the functional clearance 7 corresponds to the distance between the edges of the elements protruding from the outer wall 20 of the bulb 2 and the edges of the elements protruding from the inner wall 30 of the bowl 3.

The fact that the size d of the clearance 7 remains constant contributes to ensuring that there is no contact between the outer surface 30 of the bulb 3 and the inner surface 20 of the bowl 2 at the level of the functional space 6, thus avoiding any erosion of material as is seen in certain prior-art dry spice mills. Furthermore, this feature allows for the food grain to be held between the outer wall 30 of the bulb 3 and the inner wall 20 of the bowl 2, thus preventing them accidentally returning to the upper area 61 from the lower area 60 of the functional area 6.

Furthermore, according to another feature of the invention, the milling device 1 is designed such that the size d of the clearance 7 is greater than or equal to 0.1 mm and less than or equal to the average thickness of the grain to be ground, which is generally fine and slippery, e.g. less than or equal to 0.2 mm in the case of flaxseed, such that the grain cannot leave the device intact and their grinding is ensured.

Furthermore, in order to increase the grinding output, the invention provides for the means that the upper area 61 has to move the grain to the lower area 60 of the functional area 6 to have a specific structure.

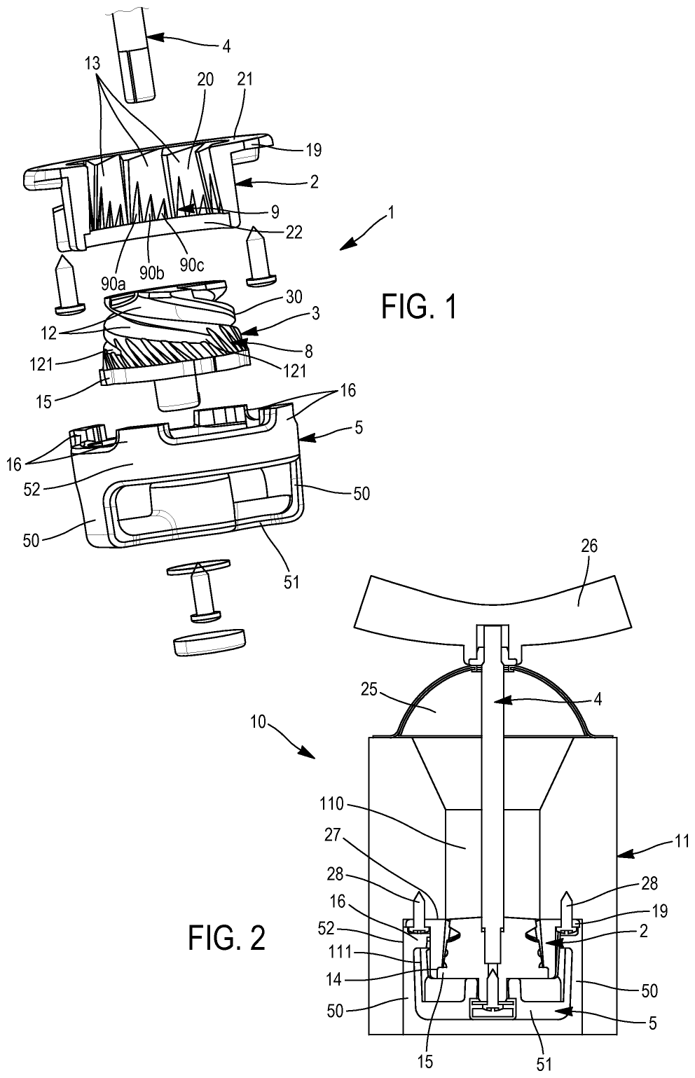

Thus, referring in particular to FIGS. 1, 6, and 9, these means include, on the one hand, a plurality of helical grooves 12 having a starting end 120 and a terminating end 121. In the embodiment shown, the helical grooves 12 are four in number and extend from the top 31 of the bulb 3, around its outer wall 30, over a length substantially corresponding to one half-turn of the bulb 30, whilst their depth progressively decreases between their starting end 120 and their terminating end 121.

On the other hand, the means for moving the grain include a plurality of splines 13, e.g. 10 splines 13, staggered over the inner wall 20 of the bowl 2 and suited to cooperate with the grooves 12 of the bulb 3, and extending from the upper edge 21 towards the lower edge 22 of the bowl 2. It should further be noted that the axis Y of the splines 13 forms an angle α of between 85 and 95° with a tangent of the circle defined by an upper 21 or lower edge 22 of the bowl 2, whilst their depth decreases progressively in the direction of the lower edge 22 of the bowl 2.

The means defined by the grooves 12 and the splines 13 allow for the food grain to be forced towards the lower area 60 of the functional area 6. As noted above, this lower area 60 includes a first and a second set 8, 9 of teeth formed respectively on the outer wall 30 of the bulb 3 and the inner wall 20 of the bowl 2. According to the invention, the first set 8 includes teeth 80 having an axis included at an angle β of between 40 and 60° relative to a tangent of the circle defined by the base 32 of the bulb 3. Furthermore, the second set 9 of teeth 90 includes a plurality of identical groups, each included within two consecutive splines 13 and consisting of teeth 90a, 90b, 90c of different heights, arranged by order of size, and having an axis parallel to that of the splines 13.

In the embodiment shown, the bowl 2 further includes a shoulder 14 extending between its lower edge 22 and its upper wall 20, whilst the bulb 3 includes a plurality of fins 15 extending along a radial axis around its outer wall 30 at the level of its base 32. The fins 15 are suited to rest on the shoulder 14 and have a length equivalent to its depth.

Because of this feature, the bulb 3 is translationally stopped, and is thus centred relative to the bowl 2, which again helps to avoid any contact between the teeth 80 and 90 and, in general, between the outer 30 and inner 20 surfaces of the bulb 3 and the bowl 2. Additionally, the fins 15 also allow for any grind stuck to the shoulder 14 to be scraped off.

In order to allow for quick, easy cleaning of the milling device 1 according to the invention, it is also provided that the bulb 2 and the bowl 3 are assembled by means for temporary joining that do not require any tools for dismantlement.

In the embodiment shown, they are defined by a flange 5, preferably made of flexible material that allows it to guarantee a constant holding force. The flange 5 includes a U-shaped part having two lateral branches 50 and one transverse branch 51 on which the bulb 2 is rotatably mounted. The free ends of the two lateral branches 50 of the U-shaped part also support a ring 52 suited to extend around the bulb 2 and having a diameter adjusted to that of the outer surface 20 of the bowl 2. Furthermore, the ring 52 and the bowl 2 include means for locking the ring 52 in place relative to the bowl 2.

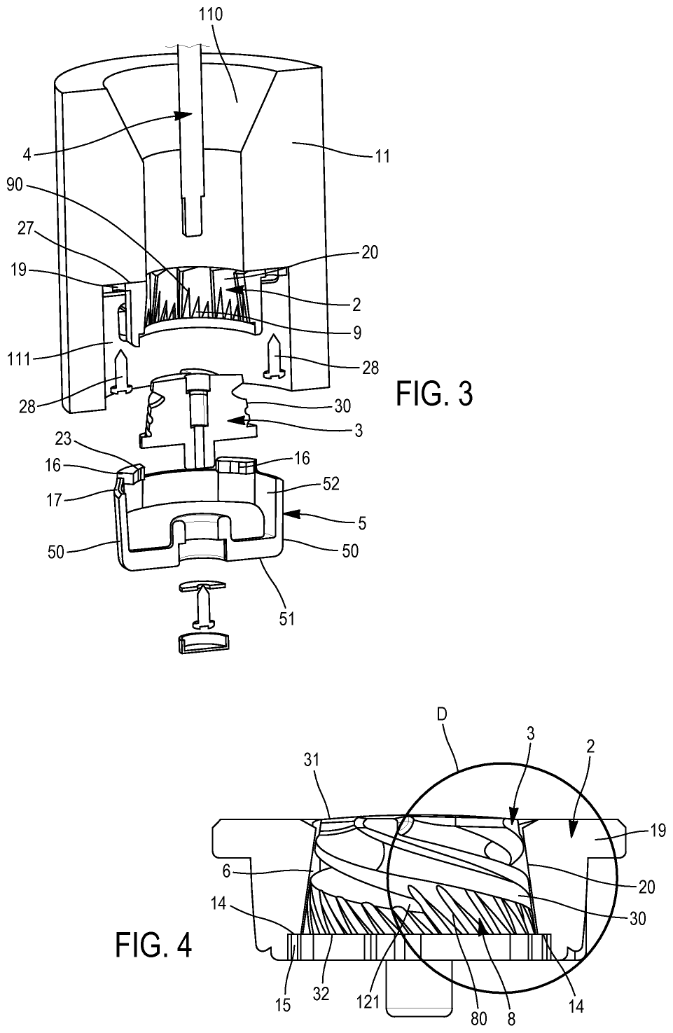

In the embodiment shown, they include two pairs of legs 16 extending in a diametrically opposite direction towards the inside of the ring 52 at its free edge 17, and two pairs of diametrically opposite L-shaped grooves 18 on the outer surface 20 of the bowl 2 between its lower edge 22 and a collar 19 bordering on its upper edge 21. In fact, each L-shaped groove 18 includes a first portion 180 that extends perpendicularly to the edges 21, 22 of the bowl 2 and a second portion 181 that extends parallel to the collar 19. Each of the legs 16 additionally includes a slot 23 suited to cooperate with a lug 24 appropriately formed in a second portion 181 of each groove 18 under the collar 19 (cf. FIG. 3, 6).

Thus, in practice, the bulb 2, equipped with its actuator rod 4 is rotatably mounted on the transverse branch 51 of the flange 5. The bowl 3 is fixed within the lower housing 111 of the body 11 of the mill 10. After being inserted into the body 11 of the mill 10 from the lower housing 111 thereof, the assembly of the bulb 2, rod 4, and flange 5 is connected with the bowl 2, by first sliding the legs 16 of the ring 52 of the flange 5 in the portion 180 of the L-shaped grooves 18, then, after rotating the assembly, by engaging the slot 23 of each leg 16 in a lug 24 of the part 181 of each groove 18 by means of reversible elastic interlocking.

To separate the bulb 2 from the bowl 3 fixed in the body 11 of the mil land allow for deep cleaning of these parts after use, e.g., by brushing, users need only first remove the actuator button from the 4 and ensure that the body 11 is empty, and then turn the mill 10 whilst holding its body in one of their hands. Then, they need only use their other hand to hold the crossbar 51 of the flange 5 in order first to pivot the assembly of the flange 5, the bulb 2, and the rod 4, and disengage the slots 23 and lugs 24, followed by sliding the assembly in order to extract it from the body 11.

In this regard, it is also worth noting that, in the embodiment shown, the lower housing 111 that contains the body 11 of the mill 10 is tubular, has a diameter adjusted to that of the collar 19 bordering on the upper edge 22 of the bowl 22, and, with the upper housing 110, forms a shoulder 27 onto which the collar 19 may be affixed by appropriate fastening means such as screws 28. Additionally, the stability of the assembly between the bowl 2 and the body 11 of the mill 10 may be further improved by equipping the shoulder 27 of the body 10 with at least one rib (not shown) formed so as to cooperate with a groove 29 of a corresponding shape included on the upper surface of the collar 19.

1. A device for grinding food grains, comprising;
a bulb with a top and a base,
an annular bowl having an upper edge and a lower edge,
wherein said bulb is suited to be rotated when the mill is actuated by means of an axial rod,
wherein the bulb and the bowl together delimit a functional area, an upper area of which comprises means for moving the grain to a lower area having gearing, being comprised of a first set of teeth (80) extending over an outer wall of the bulb, and a second set of teeth (90) extending over an inner wall of the bowl, to grind the grains,
wherein the space is formed so as to prevent any grains returning from the lower area to the upper area, and means for maintaining, between the bulb and the bowl, at the level of the functional area, a clearance designed to be suitable both to allow for the grinding of the grains and to avoid all contact between the bulb and the bowl at the level of the space.

2. The device, according to claim 1, wherein size of the clearance remains constant over the entire height of the functional area.

3. The device, according to claim 2, wherein size d of the functional clearance is greater than or equal to 0.1 mm and less than or equal to the thickness of the food grains to be ground.

4. The device, according to claim 1, wherein said outer wall of the bulb and the inner wall of the bowl are frustoconical in shape over the entirety of the functional area and have an identical cone angle between 6 and 10°.

5. The device, according to claim 1, wherein the means for moving the grain to the lower area of the functional area comprises a plurality of helical grooves having a starting end and a terminating end and extending from the top of the bulb around its outer wall over a length, corresponding to one rotation of the bulb, between a quarter turn and a three-quarter turn, wherein the depth of the grooves progressively decreases between their starting end and their terminating end, and, a plurality of splines staggered over the inner wall of the bowl and extending over the inner wall of the bowl and extending from its upper edge towards its lower edge.

6. The device, according to claim 5, wherein length of the grooves corresponds to one half-turn of the bulb.

7. The device, according to claim 5, wherein axis of the splines forms an angle α of between 85 and 90° with a tangent of the circle defined by an upper or lower edge of the bowl, whilst their depth decreases progressively in the direction of the lower edge of the bowl.

8. The device, according to claim 1, wherein said second set of teeth extending over the inner wall of the bowl comprises a plurality of identical groups, each contained between two consecutive splines and being comprised of teeth of different heights, ordered by size.

9. The device, according to claim 1, wherein the bowl comprises a shoulder extending between its lower edge and its inner wall, whilst the bulb comprises a plurality of fins extending along a radial axis around its outer wall at the level of its base, wherein the fins rest on the notch and have a length I adjusted to the depth of the shoulder.

10. The device, according to claim 1, further comprising: means for the temporary joining of the bulb and the bowl.

11. The device, according to claim 10, wherein means for temporary joining are defined by a flange comprising a U-shaped part having two lateral branches and one transverse branch on which the bulb is rotatably mounted, wherein the free ends of the two lateral branches support a ring that is designed so as to extend around the bulb and has a diameter adapted to that of the external face of the bowl, wherein the ring and the bowl include means for holding the flange in place relative to the bowl.

12. The device, according to claim 11, wherein means for holding the flange in place relative to the bowl comprises at least one pair of legs extending in the diametrically opposite direction towards the inside of the ring on its free edge, and at least one pair of diametrically opposite L-shaped grooves on the outer surface of the bowl between its lower edge and a collar bordering on its upper edge, wherein the L-shaped grooves comprise a first portion that extends perpendicularly to the edges of the bowl and a second portion that extends parallel to the collar, wherein each of the legs comprises a slot suited to cooperate with a lug that extends suitably within the second portion of a groove.

13. A mill for grinding food grains, comprising:
a device according to claim 1, and a body containing a housing to store the food grains to be ground.

14. The mill, according to claim 13, wherein said body comprises an upper housing in the shape of a funnel, the tubular part of which has a diameter adjusted to that of the inner wall of the bowl, and a lower housing having a diameter adjusted to that of the collar bordering the upper edge of the bowl, and forming a shoulder with the upper housing to which the collar can be attached by fastening means.

15. The mill, according to claim 14, wherein said shoulder comprises at least one rib formed so as to cooperate with a groove of a corresponding shape included in the upper surface of the collar.
